(19) United States
(12) Patent Application Publication
(10) Pub. No.: US 2016/0220882 A1
(43) Pub. Date: Aug. 4, 2016

(54) SELF DEFENCE TRAINING TOOL

(71) Applicant: BLUE TRAINING SYSTEMS, Delta (CA)

(72) Inventor: Clive Milligan, Delta (CA)

(21) Appl. No.: 14/838,275

(22) Filed: Aug. 27, 2015

Related U.S. Application Data
(60) Provisional application No. 62/044,017, filed on Aug. 29, 2014.

(51) Int. Cl. A63B 69/34; G09B 9/00

(52) U.S. Cl. CPC A63B 69/34; G09B 9/00

(57) ABSTRACT

A training tool comprising a target head region. The target head region comprises a pair of eye sockets and a pair of realistic eyes. Each eye is received within one of the eye sockets. Each eye may comprise a material that is deformable when a pressure is applied to the material. The training tool may optionally comprise a pair of ears on opposing sides of the target head region and an ear canal extending from one or both ears into the target head region. The self-defence training tool may be designed to allow the user to physically practice the action of inserting fingers/thumbs into the humanoid orbital (eye) socket and life like eye to simulate introducing enough kinetic energy to the eye and surrounding muscles/nerves and tissue to cause injury and a spinal reflex of withdrawal from the attacker, thus facilitating a window of opportunity for the defender to escape from further harm to her/himself.

### TECHNICAL FIELD

The present disclosure relates to a self defence training tool, and more specifically a self defence training tool comprising a target head region.

### BACKGROUND

Success in hand-to-hand combat may be measured in various ways, depending on the situation. In unfortunate circumstances where rules of engagement cannot be enforced or are otherwise unenforceable, simple survival may necessitate the permanent incapacitation of an opponent (i.e. “aim to maim”). In sanctioned and regulated combat sports like boxing, wrestling, or mixed martial arts, success may be measured by one's ability to submit, knockout, or technically out-class (i.e. out-point) an opponent. In self-defence situations, success may be measured by one's ability to simply immobilize an opponent for a long enough duration, thereby allowing one to escape further or potential harm, serious injury or potential death (i.e. “stun and run”). In law enforcement, success may be measured by an officer's ability to control or incapacitate a subject while using force in accordance with regulatory laws, act, policies and standards.

Training is an integral part of gaining competency for self defence so as to avoid or minimize injury in a situation of attack. In addition to developing sound technical skills, proper training also encompasses a thorough understanding of the bio-mechanics of the human body. The human body comprises many areas that are delicate and/or especially sensitive. Such areas generally include the groin, neck, eyes, eardrum, spine, joints, organs and various neural pressure points. Particularly in close quarter self-defence situations, the quickest way to immobilize an attacker is to strike and/or hold such delicate and/or sensitive areas of the attacker.

For law enforcement officers, fluency in striking and grappling, and knowledge of where to cause pain using an effective amount of energy in the least amount of time, must be balanced by knowledge of generally how much force to apply when delivering a particular strike, hold or application. Intentional (or even unintentional) application of excessive force by an officer, particularly that which results in unfavourable or unfortunate outcomes, may lead to performance reviews, demotions, suspensions, loss of employment, civil penalties or even criminal charges against the officer. For civilians, a less stringent set of rules is generally applied if the victim is defending themselves or someone else.

A typical human eye maintains an intraocular pressure of between ˜10 mmHg (˜0.00135 MPa) and ˜21 mmHg (˜0.0028 MPa) above atmospheric pressure (Noecker, 2014). The average intraocular pressure is thought to be around ˜15 mmHg (˜0.002 MPa) above atmospheric pressure (Stamper et al., 2006). Eye injuries may be induced by external pressure effects (e.g. blunt ocular trauma), which lead to a sudden or gradual increase in intraocular pressure. If not treated properly, eye injuries may result in partial or full vision damage. It has been shown that an average human eye ruptures at: (i) 0.36±0.20 MPa under a “static pressure” (i.e. pressure applied externally at a constant rate) of 0.02 MPa/second; and (ii) 0.91±0.29 MPa under a “dynamic pressure” (e.g. blunt ocular trauma) of 2.77 MPa/second (see Kennedy et al., 2004; Bisplinghoff et al., 2009). When the eye is contacted by a foreign object (for example, hair, sand, fingers and the like), the eye instinctively closes to protect from further similar objects entering the eye, injury or stress. Humans will then continue to voluntarily keep the ocular lens protected by closing the lids until a recovery period is complete or first aid/medical treatment is provided. It is extremely rare to be able to gouge an eye that results in complete removal of the eye ball from the eye socket or orbit. There are six ocular muscles that allow the eye to move about and operate under normal circumstances. These muscles and other tissues (nerve bundles/arteries/fatty tissue) act to keep the eye ball inside the socket; however, if the facial bony structures are fractured/removed by blunt force trauma or for example “gunshot wounds”, then the eye ball may exit the eye socket.

The tympanic membrane (i.e. eardrum) is a thin membrane that divides the external ear from the middle ear. The thickness of the eardrum may vary between 40-120 micrometres (Kuypers et al., 2006). The eardrum may be damaged in many ways, including infection of the middle ear, penetration, poking, barotraumas, and acoustic trauma. The eardrum is a delicate anatomical feature. An overpressure of 100 kPa will almost certainly guarantee rupture of the eardrum (Staab, 2012). It has also been reported that an eardrum may rupture at pressure differentials of between 35-69 kPa (Staab, 2012).

It is generally difficult, unsafe and legally irresponsible to practice on a real person the proper application of force against sensitive and/or delicate areas of the body, for defence or incapacitation purposes. As such, it is desirable to have a training apparatus or tool comprising one or more features replicating (e.g. in physical structure) one or more of such delicate and/or sensitive areas, such that a user may gain experience in striking or holding these areas without necessarily applying excessive force to a real person. Presently it is only possible to practice these techniques using a training dummy that has flat eyelids and unrealistic eyes and therefore the user does not benefit mentally and physically from a reality based experience of passing a frontal plane of the face and entering the orbit to simulate causing injury.

### SUMMARY

According to a first aspect, there is provided a training tool comprising a target head region comprising a pair of eye sockets and a pair of realistic eyes. Each eye is received within one of the eye sockets.

At least one of the eyes may comprise a material that is deformable when a pressure is applied to the eye. At least one of the eyes may be insertable into and removable from one of the eye sockets.

At least one of the eyes may comprise a shell forming a chamber filled with an aqueous material. The aqueous material may be a soft gel. At least one of the eyes may comprise a shell forming a chamber filled with a sponge or foam material. The shell may comprise an elastomeric material. At least one of the eyes may comprise a polyurethane foam material.

An internal pressure of at least one of the eyes may be between about 10 mmHg to about 21 mmHg above atmospheric pressure. The internal pressure of the eye may be 15.5±2 mmHg above atmospheric pressure.

At least one of the eye sockets may comprise a tapered section which tapers toward a back of the target head region. The tapered section may comprise a tapered four walled conical section. A back of at least one of the eyes may comprise a tapered projection that tapers away from a front of the eye. The tapered projection may be dimensioned to fit within the tapered section of the eye socket. The tapered projection may be attached to the target head region or to the eye socket by a cord.

One or more than one pressure sensor may be coupled to at least one of the eyes for measuring an amount of pressure applied to the eye. The training tool may further comprise a sound box electrically communicative with the pressure sensor. A volume of the sound box may increase when the pressure applied to the eye increases. The sound box may be activated when the pressure applied to the eye is above a predetermined threshold pressure.

The target head region may further comprise a pair of ears on opposing sides of the target head region and an ear canal extending from one or both of the ears into the target head region. The ear canal may further comprise a membrane that seals the ear canal. The membrane may comprise an elastomeric material. One or more than one pressure sensor may be coupled with the membrane for measuring an amount of pressure applied to the membrane. A whistle valve may be positioned in the ear canal.

The training tool may further comprise a handle. The handle may comprise a metal or plastic core covered with a foam gripping surface. The handle may comprise a glove.

The training tool may further comprise an attachment mechanism for attaching the training tool to an object. The attachment mechanism may be one or more than one strap. The strap may be adjustable.

The training tool may further comprise a latex mask positioned over the target head region.

According to another aspect, there is provided a kit comprising the training tool of the first aspect and an addition eye or additional pair of eyes. The additional eye or the additional pair of eyes may be insertable into and removable from one of the eye sockets. The additional eye or the additional pair of eyes may comprise a material that is deformable when a pressure is applied to the material.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more exemplary embodiments:

FIG. 1 is a perspective view of a self defence training tool according to an embodiment comprising a target head region, the target head region including a pair of eyes and a pair of ears.

FIG. 2 is a cutaway side view of the target head region showing one of the eyes in an eye socket.

FIG. 3a is a photo of the pair of eyes made from a polyurethane foam material and FIG. 3b is a photo of one of the eyes with numbers marked on the eye for training purposes.

FIG. 4a is a side view of the self defence training tool showing the left ear and FIG. 4b is a cut away view of the left ear.

FIGS. 5a, 5b and 5c are photos of the side, front and back of the self defence training tool according to an embodiment comprising a target head region with a handle connected to the base of the target head region.

### DETAILED DESCRIPTION

Directional terms such as “top,” “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment.

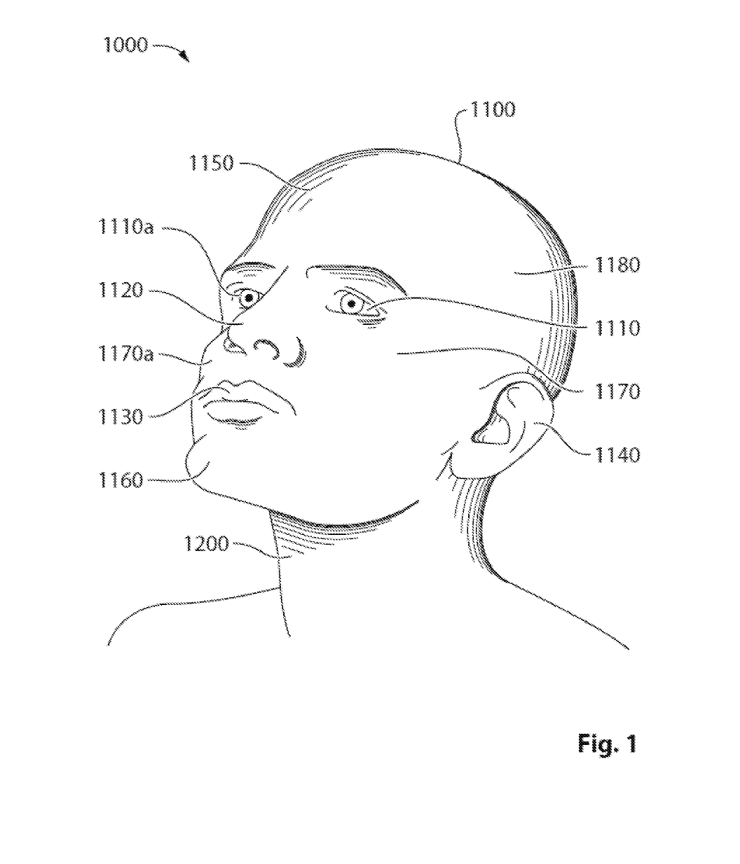

Referring to FIG. 1, there is shown a self defence training tool 1000 according to an embodiment. Self defence training tool 1000 comprises a target head region 1100 attached to a neck region 1200. The target head region 1100 comprises facial features including left eye 1110, right eye 1110a, nose 1120, mouth 1130, left ear 1140, right ear (not shown), forehead 1150, chin 1160, cheeks 1170 and 1170a, left temple 1180, and right temple (not shown). The self defence training tool 1000 is of a size that is comparable to, and consists of the same facial features as an adult human head. The target head region 1100 and the neck region 1200 may be constructed of a material that provides a durometer hardness that is generally rigid at normal room and environmental temperatures and becomes pliable when heated to allow molding of facial anatomical features. For example the target head region 1100 and the neck region 1200 may be constructed of polyvinyl chloride (PVC) and/or polyurethane (PU) foam. The target head region 1100 may be connected to the neck region 1200 or the head and neck regions (1100 and 1200) may be molded as one continuous structure. To improve portability, the target head region 1100 and optionally the neck region 1200 may be hollow; however, the target head region 1100 and/or the neck region 1200 may alternatively be solid or semi-solid. In alternative embodiments (not shown), the self defence training tool 1000 may comprise the target head region 1100 without the neck region 1200. A thin pliable latex mask (not shown) may be stretched over the target head region 1100 and target neck region 1200 if present. The mask may be skin-coloured and marked to look like real skin. The mask may provide a realistic skin texture and may also provide eye lids and eye lashes and other facial features which may make the self defence training tool 1000 look more like a real human head. The mask may be easily removed and replaced with a different mask to change the look of the self defence training tool 1000.

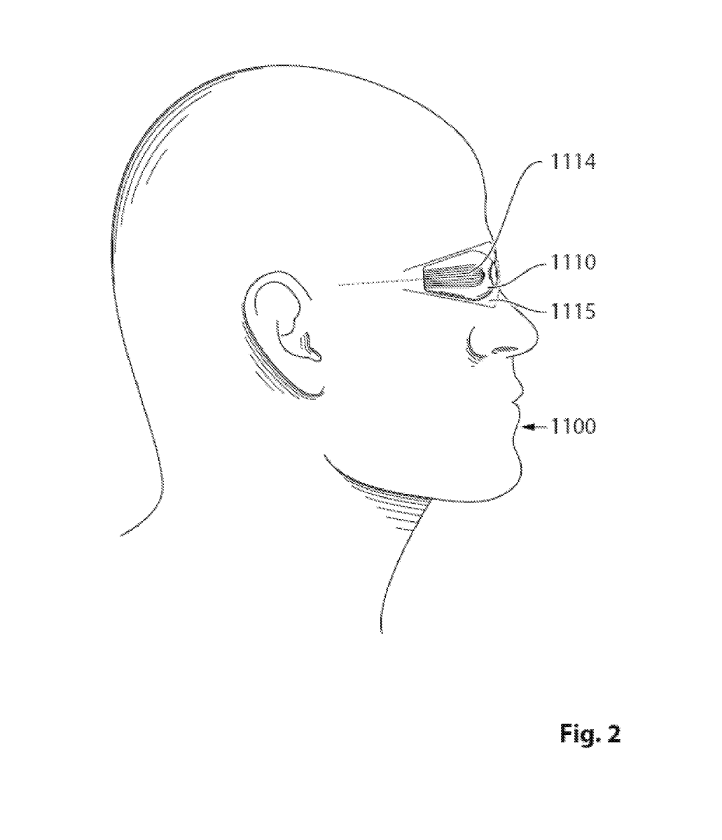

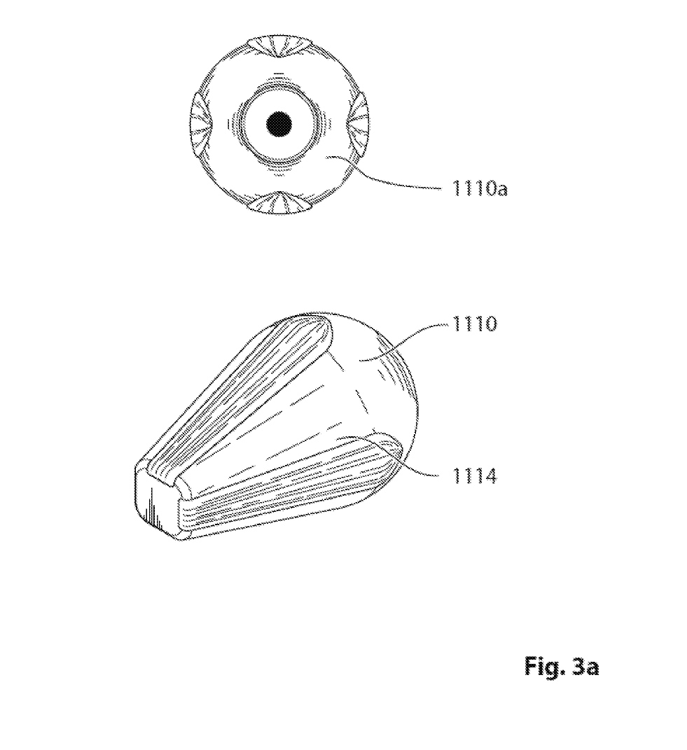

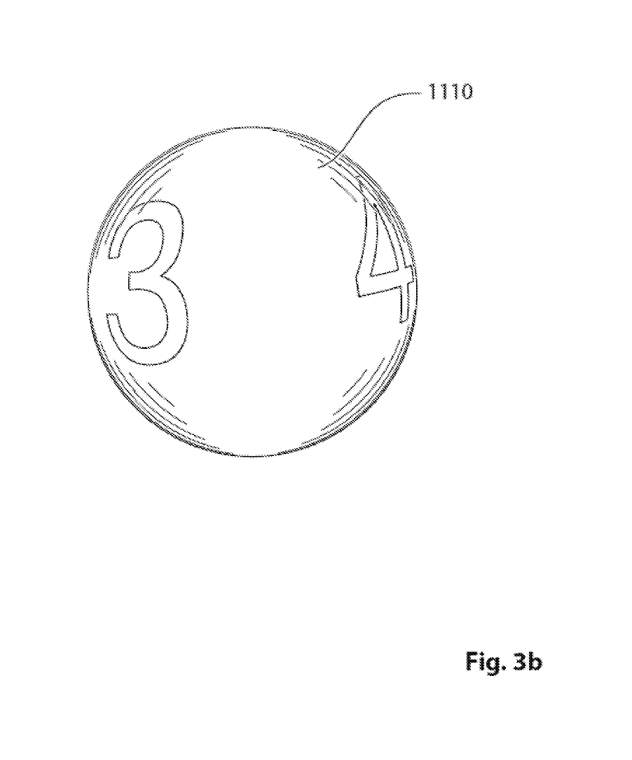

As shown in FIG. 2, eye 1110 is positioned in an eye socket or orbit 1115. Eye socket 1115 is conical in shape, and includes a tapered section which tapers as it extends towards the back of the target head region 1100. The eye socket 1115 may be dimensioned to correspond to the dimensions of an average human adult eye socket (orbit). Eye 1110 has a tapered projection 1114 at the posterior pole of the eye which corresponds in shape to the taper of the eye socket 1115 (also shown in FIG. 3a). The tapered projection 1114 helps ensure that the eye 1110 is correctly orientated within the eye socket 1115 and may prevent the eye 1110 from spinning around from back to front when the eye 1110 is positioned in the eye socket 1115. To insert the eye 1110 into the socket 1115, the eye 1110 is deformed by squeezing and then the eye 1110 is inserted (tapered projection 1114 first) into the socket 1115. Once the eye 1110 is positioned in the socket 1115, the eye 1110 expands to its un-deformed state and fits snugly within the socket 1115. This generally holds the eye 1110 in place within the eye socket 1115 without the need for additional fixing means, such as adhesive. In an alternative embodiment (not shown) the eye may not have a tapered projection 1114 and the eye socket 1115 may not be tapered and an adhesive or other means for fixing the eye 1110 in the eye socket 1115 may be utilized.

The eye projection 1114 may be attached to a first end of a cord, such as a bungee cord. The cord may pass through the apex of the eye socket 1115, and a second end of the cord may be attached to the back of the target head region 1100. In an alternative embodiment (not shown), the second end of the cord may be attached to the back of the eye socket 1115. In the event that the eye 1110 is deformed by application of pressure or force to a point that it falls out of, or is removed from the socket 1115, the eye 1110 remains attached to the target head region 1100 via the cord, thereby reducing the chance of losing or misplacing the eye 1110. The cord may be coloured red to resemble an optic nerve. In alternative embodiments, the cord may be coloured as desired or not coloured at all.

Each eye 1110, 1110a may be made from a gel, foam or sponge like material that is deformable under pressure, for example a polyurethane foam material. In alternative embodiments, the eye may comprise a shell that may be constructed of an elastomeric material that replicates the viscoelasticity of the sclera. The shell forms a chamber which may be filled with a soft-gel material that mimics the consistency of the vitreous humour, or other aqueous fluids or sponge-like materials, such as silicone sponges, natural hydrogels, silicon oils, silicone gels and semifluorinated alkanes. Each eye 1110, 1110a may be substantially spherical or spheroidal in shape. The internal pressure of the eye 1110, 1110a may be about 15.5±2 mmHg above atmospheric pressure to mimic the internal pressure of a human eye. In alternative embodiments however, the internal pressure of eye 1110, 1110a may be selected from the range of about 10 mmHg to about 21 mmHg above atmospheric pressure. To replicate a typical adult human eye, the eye 1110, 1110a may have a diameter of about 24 mm. However, the size of the eye 1110, 1110a may be modified as desired.

Referring now to FIG. 3a, eyes 1110 and 1110a are made of a polyurethane foam material and coloured like a real human eye. The eye projection 1114 includes colouration representing the red muscles and fatty tissue, so that a user can see how much pressure needs to be applied to cause rotation of the eye to expose the red muscles and fatty tissue. In an alternative embodiment shown in FIG. 3b, eye 1110 includes numbers evenly spaced around the surface of the eye 1110, which provide a user with a visual indication that enough pressure has been applied to rotate the eye stimulating stretching of the ocular muscle past normal range. In alternative embodiments (not shown) other indicia, for example letters, symbols or patterns made be on the eye surface instead of numbers. In further alternative embodiments, no colour or indicia may be provided on the surface of the eye 1110 and 1110a. The self defence training tool 1000 may be provided as a kit with two or more sets of eyes for example, one set of eyes may be coloured to mimic real human eyes and the other set of eyes may include indicia for training purposes as discussed above. Spare eyes may alternatively or additionally be provided in the kit in case one of the eyes 1110, 1110a is lost or damaged. A user can switch between the different sets of eyes 1110 and 1110a or replace a damaged eye 1110, 1110a by removing the eye(s) 1110, 1110a from the eye socket(s) 1115 using a finger, thumb or other object and inserting the replacement eye(s) 1110, 1110a into the eye socket 1115 as discussed above in more detail.

A plurality of pressure sensors (not shown), such as piezoelectric sensors, may be attached to, and evenly distributed across, the interior or exterior surface of the eye 1110, 1110a. The pressure sensors generate signals upon detecting a pressure that is applied to the eye 1110, 1110a. The signals can be sent to a microcontroller or microprocessor (not shown), which determines the amount of pressure and the mechanical stress applied to the eye 1110, 1110a corresponding to each received signal. The information may then sent to and displayed on a graphical user interface module (not shown), thereby providing the user with information regarding his/her application of pressure (including the rate and amount) to the eye 1110.

A sound box (not shown) may be located in the mouth 1130 of the target head region 1100 or in the eye socket 1115 or anywhere in the self defence training tool 1000. The sound box is configured to be responsive to signals from the pressure sensor received by the microcontroller. If the signals received by the microcontroller correspond to an application of pressure consistent with “static pressure” (see Background), the sound box may be activated when the applied pressure reaches 0.36 MPa. If the signals received by the microcontroller correspond to an application of pressure consistent with “dynamic pressure” (see Background), the sound box may be activated when the applied pressure reaches 0.91 MPa. In other words, the sound box may be activated when the measured applied pressures correspond to the rupture pressures of the average human eye. When activated, the sound box may play a recording of a human screaming in agony, thereby adding an element of reality to the training. In alternative embodiments, an activated sound box may play a different recording.

In an alternative embodiment, the sound box may be immediately activated upon the microcontroller receiving one or more signals from the pressure sensors. When the applied pressure is a “static pressure”, the volume of the recording may escalate with an increase in applied pressure on the eye 1110, 1110a until the volume of the recording reaches a maximum volume corresponding to an applied pressure of 0.36 MPa. Similarly, if the signals received by the microcontroller correspond to an application of pressure consistent with “dynamic pressure”, the volume of the “scream” may escalate with an increase of applied dynamic pressure on the eye 1110, 1110a. The volume of the speakers in the sound box may be adjustable so that a user can control the volume of sound emitted or choose not to have sound at all.

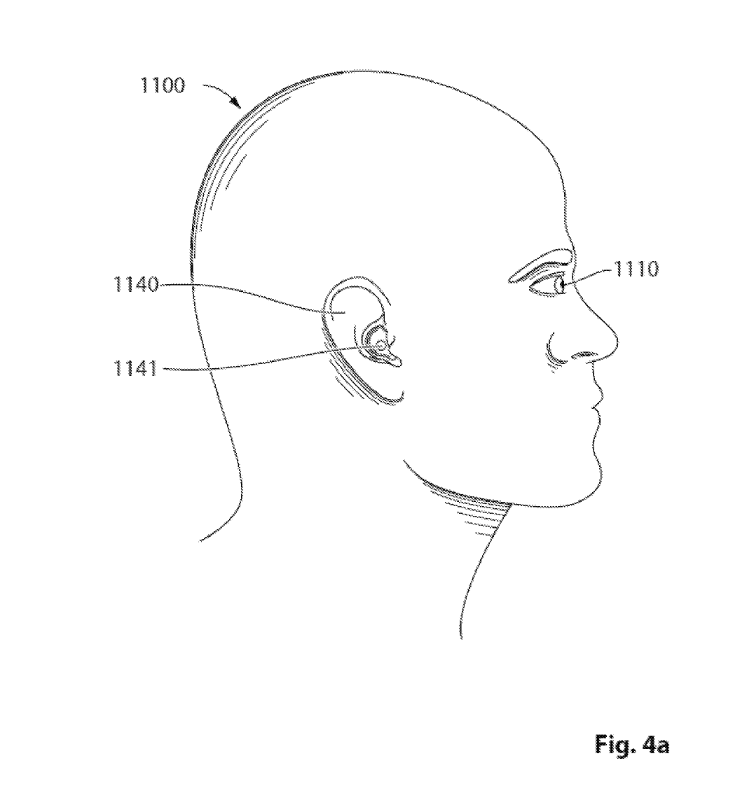

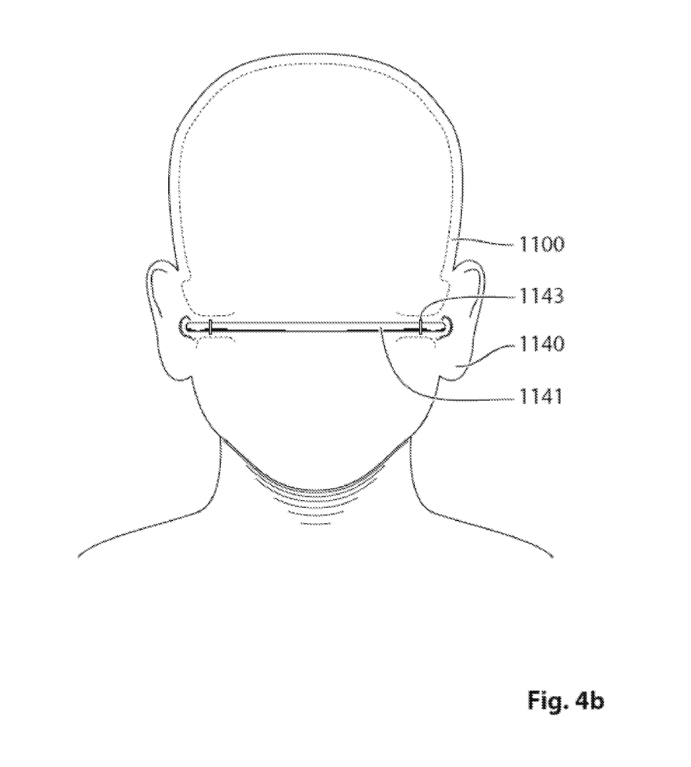

Ears 1140 and 1140a may be constructed of a flexible elastomeric material having at least a similar pliability as an adult human ear. Referring to FIGS. 4a and 4b, the left ear 1140 is shown and includes an ear canal (hollow tube) 1141 extending from the ear 1140 into the target head region 1100. Sealing the ear canal 1141 is a thin membrane 1143 constructed of a material suitable for mimicking the eardrums of an adult human. Membrane 1143 may be constructed of any material known in the art that replicates an eardrum, for example tissue, silicon discs or rubber domes. The right ear (not shown) similarly has an ear canal (not shown) extending into the target head region 1100 and a thin membrane sealing the ear canal. In one embodiment (not shown) the ear canals of the left and right ear may be connected by a tube. A pressure sensor (not shown), such as a resistive pressure sensor, may be disposed on the inner surface of membrane 1143. The pressure sensor senses the degree of deflection experienced by the membrane 1143 when a pressure is applied to the membrane 1143. In an alternative embodiment a whistle valve may be used in addition to, or instead of, the pressure sensor. The whistle valve (not shown) may be located in the ear canal 1141 or in the tube connecting the ear canals if present. The volume of the whistle of the whistle valve may increase with increased air pressure rushing through the valve.

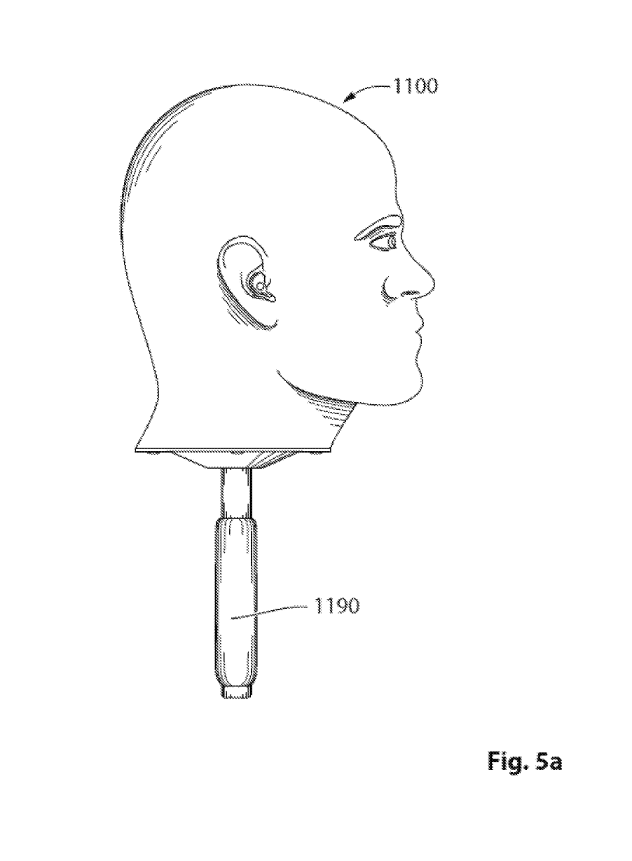

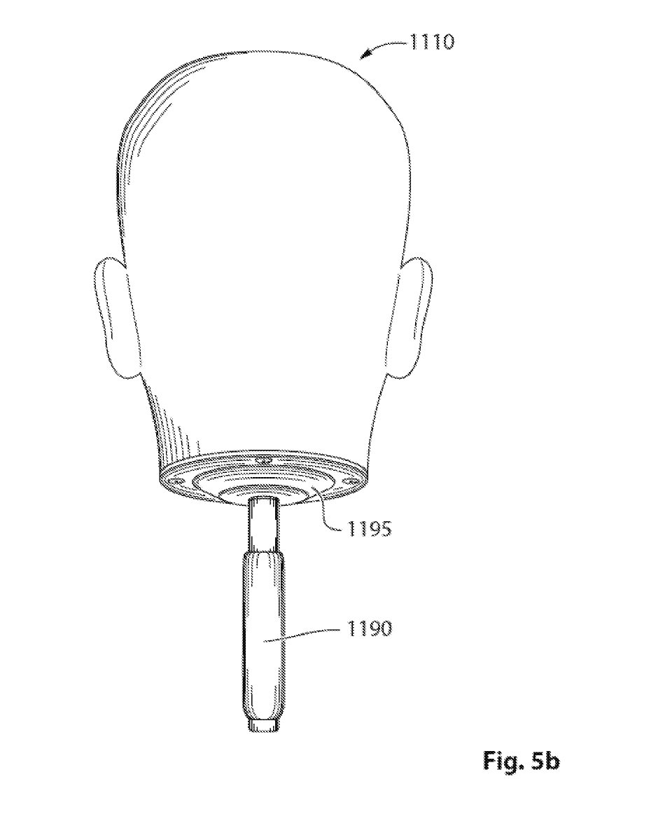

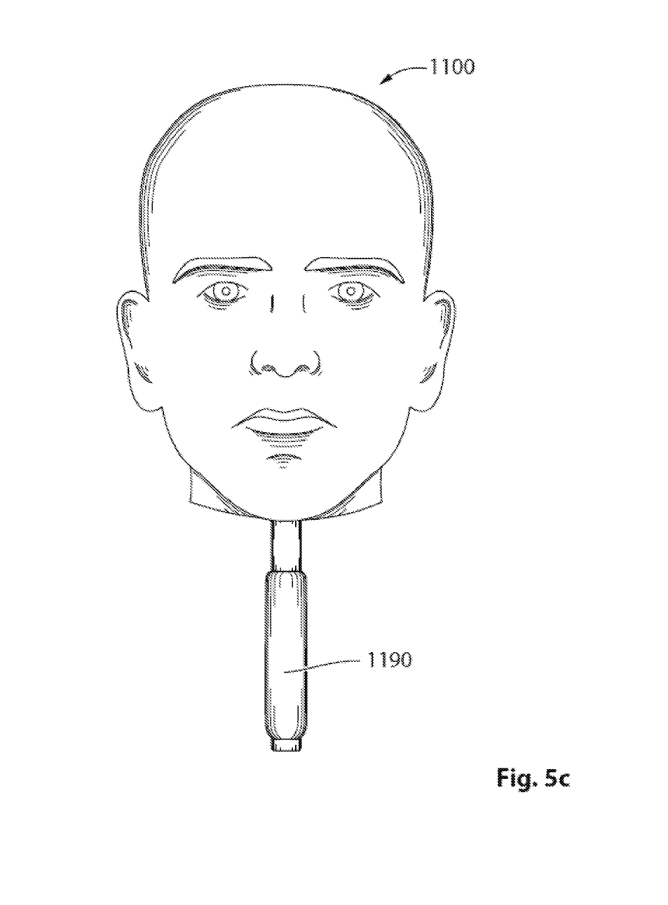

Referring now to FIGS. 5a, 5b and 5c there is shown photos of the side, front and back of the self defence training tool 1000 according to an embodiment. The self defence training tool 1000 includes the target head region 1100 and a handle 1190 attached to the base of the target head region by a plate 1195 (as shown in FIG. 5b). The handle 1190 allows a trainer or user to hold the self defence training tool 1000 at a desired height. In alternative embodiments (not shown), the handle may be any handle known in the art, such as a glove or a looped handle, and may be connected to any part of the target head region 1100 or target neck region 1200 if present.

The self defence training tool 1000 may be provided with an attachment mechanism (not shown) for attaching the tool 1000 to another object such as a free standing punching bag, the body of a mannequin, a head rest in a car or any object which allows the tool 1000 to be used for solo training. For example Velcro™ straps or belt straps may be provided which may be attached to the target head region 1100 or the neck region 1200 or to the handle if present. The straps can wrap around the object and fastened to themselves to attach the tool 1000 to the object. The straps may be adjustable so that the tool 1000 may be attached to different sized objects.

The self defence training tool 1000 may be used for self defence training, either solo training when the self defence training tool 1000 is attached to another object using the attachment mechanism as discussed above, or with the user or another person holding the self defence training tool 1000 by its handle. The holder can move the self defence training tool 1000 around and the user can practice locating and trapping the self defence training tool 1000 and inserting one or more fingers and/or thumb into the eye 1110, 1110a. The self-defence training tool may beneficially allow the user to physically practice the action of inserting fingers/thumbs into the humanoid orbital (eye) socket and life like eye to simulate introducing enough kinetic energy to the eye and surrounding muscles/nerves and tissue to cause injury and a spinal reflex of withdrawal from the attacker, thus facilitating a window of opportunity for the defender to escape from further harm to her/himself. The eyes 1110, 1110a may be marked or coloured in some way as discussed above, so that a user can see how much pressure needs to be applied and what technique to use in real life situation to rotate the eye 1110, 1110a in the eye socket 1115 to a point where the ocular muscles are stretched past their normal range resulting in pain. The self defence training tool 1000 may further be equipped with pressure sensors and/or sound boxes as discussed above, which provide a sound and/or visual indication that enough pressure has been applied to cause an attacker pain which in a self defence situation would give the person being attacked time to escape.

The self defence training tool 1000 may also be provided with ears 1140, including an ear canal 1141 and a membrane 1143 representing an ear drum as discussed above. A user may beneficially be able to practice hitting the ear(s) 1140 with a cupped hand/palm. The concept and principle of this technique is that when the hand makes contact with a real human ear and continues to follow through, it flattens out and projects a pocket of air towards the ear drum. If the ear drum is ruptured (depending on the amount of specific pressure) the inner ear may be affected resulting in stimulus to the balancing structures/bones. This will often result in disorientation and can cause vertigo. Once balance is affected and a spinal reflex of withdrawal occurs, the victim will have created a window of opportunity to escape from further harm to him/herself.

As the self defence training tool 1000 is generally portable, it may be used in a number of training situations including training at home or in stimulation self defence or combat situations, such as in security, police, civilian self defence, martial arts, or military training. Furthermore, the tool 1000 may be gripped or positioned in numerous ways, such as under the arm to replicate a head lock hold on an attacker, and to allow a user to train for different self defence situations and dimensional orientations of the attacker, for example standing face to face, being attached from behind, or being attacked from above with the victim on the ground in a supine or prone position.

It is contemplated that any part of any aspect or embodiment discussed in this specification can be implemented or combined with any part of any other aspect or embodiment discussed in this specification. While particular embodiments have been described in the foregoing, it is to be understood that other embodiments are possible and are intended to be included herein. It will be clear to any person skilled in the art that modification of and adjustment to the foregoing embodiments, not shown, is possible.

### REFERENCES

Bisplinghoff J. A. et al., “High-rate internal pressurization of human eyes to predict globe rupture”, Arch Ophthalmol., 2009, 127(4): 520-523.
Funk M. and Schnuppel J., “Strangulation Injuries”, Wisconsin Medical Journal, 2003, 102(3): 41-45.
Kennedy E. et al., “Prediction of Severe Eye Injuries in Automobile Accidents: Static and Dynamic Rupture Pressure of the Eye”, Annu Proc Assoc Adv Automot Med., 2004, 48:165-79.
Kuypers L. C. et al., “Thickness distribution of fresh and preserved human eardrums measured with confocal microscopy”, Otol Neurotol., 2006, 27(2): 256-64.
Noecker R. J., “Glaucoma Overview” emedicinehealth—experts for everyday emergencies (20 Jun. 2014), online: emedicinehealth <http://www.emedicinehealth.com/glaucoma_overview/article_em.tm>.
Stamper R. L. et al., “Intraocular Pressure: Measurement, Regulation, and Flow Relationships” in Duane's Foundations of Clinical Ophthalmology (Lippincott Williams & Wilkins, 2006), chapter 7.
Staab W., “Eardrum Rupture: At What Pressure?”, Canadian Hearing Report, 2012, 7(1), 12-14.

1. A training tool comprising a target head region comprising a pair of eye sockets and a pair of realistic eyes, wherein each eye is received within one of the eye sockets.

2. The training tool of claim 1, wherein at least one of the eyes comprises a material that is deformable when a pressure is applied to the eye.

3. The training tool of claim 1, wherein at least one of the eyes is insertable into and removable from one of the eye sockets.

4. The training tool of claim 1, wherein at least one of the eyes comprises a shell forming a chamber filled with a soft gel.

5. (canceled)

6. The training tool of claim 1, wherein at least one of the eyes comprises a shell forming a chamber filled with a sponge or foam material.

7. The training tool of claim 4, wherein the shell comprises an elastomeric material.

8. The training tool of claim 1, wherein at least one of the eyes comprises a polyurethane foam material.

9-10. (canceled)

11. The training tool of claim 1, wherein at least one of the eye sockets comprises a tapered section which tapers toward a back of the target head region.

12. (canceled)

13. The training tool of claim 11, wherein a back of at least one of the eyes comprises a tapered projection that tapers away from a front of the eye, the tapered projection being dimensioned to fit within the tapered section of the eye socket.

14. (canceled)

15. The training tool of claim 1, wherein one or more than one pressure sensor is coupled to at least one of the eyes for measuring an amount of pressure applied to the eye.

16. The training tool of claim 15, further comprising a sound box electrically communicative with the pressure sensor.

17. The training tool of claim 16, wherein a volume of the sound box increases when the pressure applied to the eye increases.

18. The training tool of claim 16, wherein the sound box is activated when the pressure applied to the eye is above a predetermined threshold pressure.

19. The training tool of claim 1, wherein the target head region further comprises a pair of ears on opposing sides of the target head region and an ear canal extending from one or both of the ears into the target head region.

20. The training tool of claim 19, wherein the ear canal further comprises a membrane that seals the ear canal.

21. The training tool of claim 20, wherein the membrane comprises an elastomeric material.

22. The training tool of claim 20, wherein one or more than one pressure sensor is coupled with the membrane for measuring an amount of pressure applied to the membrane.

23. (canceled)

24. The training tool of claim 1, further comprising a handle.

25. The training tool of claim 24, wherein the handle comprises a metal or plastic core covered with a foam gripping surface.

26. The training tool of claim 24, wherein the handle comprises a glove.

27-33. (canceled)
